(19) United States
(12) Patent Application Publication
(10) Pub. No.: US 2014/0119696 A1
(43) Pub. Date: May 1, 2014

(54) OPTICAL FIBER CONNECTOR AND OPTICAL COMMUNICATION APPARATUS WITH SAME

(71) Applicant: HON HAI PRECISION INDUSTRY CO., LTD., New Taipei (TW)

(72) Inventor: I-Thun LIN, New Taipei (TW)

(73) Assignee: HON HAI PRECISION INDUSTRY CO., LTD., New Taipei (TW)

(21) Appl. No.: 13/873,147

(22) Filed: Apr. 29, 2013

(30) Foreign Application Priority Data
Oct. 26, 2012 (TW) 101139854

(51) Int. Cl. G02B 6/42

(52) U.S. Cl. CPC G02B 6/42
USPC 385/88

(57) ABSTRACT

The disclosure relates to an optical fiber connector for coupling an optical fiber to a corresponding photoelectric element. The optical fiber connector includes a first end, a second end opposite to the first end, and lens portion. The optical fiber connector defines a fixing hole in the first end for fixing an end of the optical fiber therein and a receiving groove in the second end. The receiving groove forms a bottom surface in the second end of the optical fiber connector, and the bottom surface defines a blind hole. The lens portion is formed on a bottom surface of the blind hole, and a peripheral edge of the lens portion coincides with an inner side surface of the blind hole.

### BACKGROUND

1. Technical Field

The present disclosure relates to connectors and communication apparatuses with the connectors, particularly to an optical fiber connector and an optical communication apparatus with the optical fiber connector.

2. Description of Related Art

In optical communication apparatuses, optical fiber connectors are configured for connecting optical fibers and aligning the optical fiber with corresponding photoelectric elements. An optical fiber connector includes a first end surface, a second end surface opposite to the first end surface, and a lens portion. The optical fiber connector defines a fixing hole in the first end surface for fixing an optical fiber and a receiving groove in the second end surface. The lens portion is formed on a bottom surface of the receiving groove. To reduce insertion loss, the lens portion must be concentric with the fixing hole. Therefore, when the optical fiber connector is made by an injection molding method, shape deviation often occurs to the lens portion which causes misalignment between the lens portion and the fixing hole.

What is needed therefore is an optical fiber connector and an optical communication apparatus with the optical fiber connector addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an isometric view of one embodiment of an optical fiber connector.

FIG. 2 is a cross-sectional view of the optical fiber connector, taken along line II-II.

### DETAILED DESCRIPTION

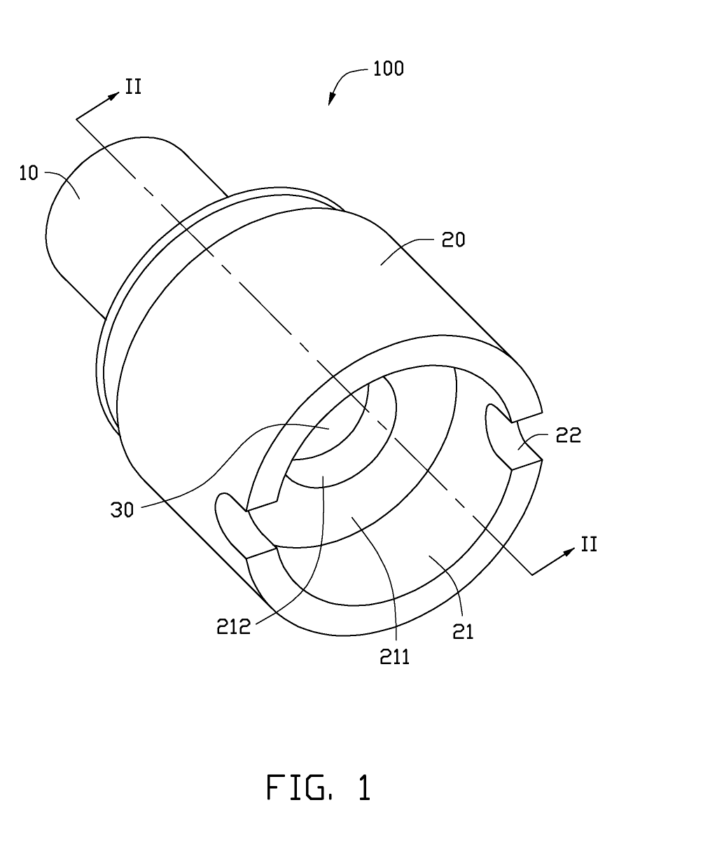

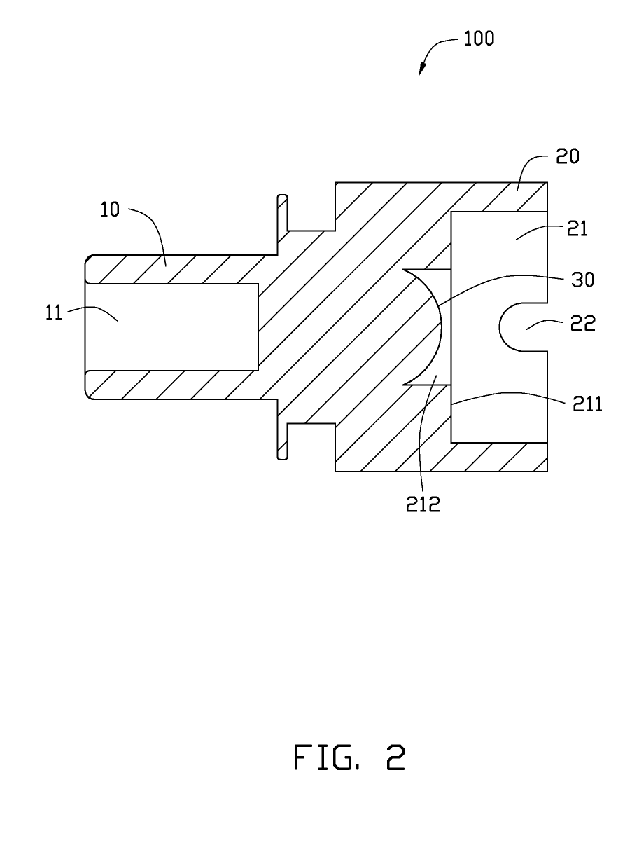

FIGS. 1-2 show one embodiment of an optical fiber connector 100 configured for connecting an optical fiber (not shown) to a corresponding photoelectric element (not shown). The optical fiber connector 100 includes a first end 10, a second end 20 opposite to the first end 10, and a lens portion 30. The optical fiber is connected to the first end 10, and the photoelectric element is connected to the second end and optically aligned with the lens portion 30.

The optical fiber connector 100 defines a fixing hole 11 in the first end 10 and a receiving groove 21 in the second end 20. The fixing hole 11 is configured for receiving and fixing an end of the optical fiber therein. The receiving groove 21 forms a bottom surface 211 in the optical fiber connector 100. The optical fiber connector 100 further defines a blind hole 212 in the bottom surface 211. The lens portion 30 is formed on a bottom surface of the blind hole 212, and a peripheral edge of the lens portion 30 coincides with an inner side surface of the blind hole 212. In other words, a shape and size of a cross-sectional surface of the blind hole 212 is the same shape and size of the peripheral edge of the lens portion 30. Therefore, in a concentricity measurement of the optical fiber connector 100, the inner side surface of the blind hole 212 can be caught by a measurement device (not shown) as the peripheral edge of the lens portion 30. In the embodiment, the lens portion 30 is an aspherical lens.

The optical fiber connector 100 further defines two engaging cutouts 22 in the second end 20. The engaging cutouts engage with the photoelectric element, to prevent the optical fiber connector 100 and the photoelectrical from rotating. In the embodiment, each cutout 22 is substantially arch-shaped. The number and shape of the cutouts 22 can be changed according to different requirements.

In use, an end of an optical fiber (not shown) is received and fixed in the fixing hole 11, a photoelectric element (not shown) is engaged with the second end 20 of the optical fiber connector 100, and the photoelectric element is optically aligned with the lens portion 30. The optical fiber, the optical fiber connector 100, and the photoelectric element cooperatively form an optical transmitting apparatus for transmitting optical signals.

The optical fiber connector 100 can be molded by an ejection mold (not shown). Because the lens portion 30 is formed on the bottom surface of the blind hole 212 with an inner side surface coinciding with the peripheral edge of the lens portion 30, the inner side surface of the blind hole 212 can be caught by the measurement device as the peripheral edge of the lens portion 30. Therefore, even if a shape deviation of the peripheral edge occurs because of the viscosity of the melted molding material, a measurement precision of the optical fiber connector 100 can still be ensured.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A optical fiber connector for coupling an optical fiber to a corresponding photoelectric element, the optical fiber connector comprising a first end, a second end opposite to the first end, and a lens portion, wherein a fixing hole is defined in the first end for fixing an end of the optical fiber therein, a receiving groove is defined in the second end, the receiving groove having a bottom surface, a blind hole defined in the bottom surface of the receiving groove, the lens portion is formed on a bottom surface of the blind hole, with a peripheral edge of the lens portion coinciding with an inner side surface of the blind hole.

2. The optical fiber connector of claim 1, wherein the lens portion is an aspherical lens.

3. The optical fiber connector of claim 1, wherein the optical fiber connector defines two engaging cutouts in the second end providing an engagement with the photoelectric element.

4. The optical fiber connector of claim 3, wherein each cutout is substantially arch-shaped.

5. An optical communication apparatus, comprising:
an optical fiber connector for coupling an optical fiber to a corresponding photoelectric element, the optical fiber connector comprising a first end, a second end opposite to the first end, and a lens portion, wherein a fixing hole is defined in the first end for fixing an end of the optical fiber therein, a receiving groove is defined in the second end, the receiving groove having a bottom surface, a blind hole is defined in the bottom surface, the lens portion is formed on a bottom surface of the blind hole, with a peripheral edge of the lens portion coinciding with an inner side surface of the blind hole.

6. The optical communication apparatus of claim 1, wherein the lens portion is an aspherical lens.

7. The optical communication apparatus of claim 1, wherein the optical fiber connector defines two engaging cutouts in the second end providing an engagement with the photoelectric element.

8. The optical communication apparatus of claim 7, wherein each cutout is substantially arch-shaped.
